(19) United States
(12) Patent Application Publication
(10) Pub. No.: US 2008/0249802 A1
(43) Pub. Date: Oct. 9, 2008

(54) Intelligent medical device

(76) Inventor: Sandro Micieli, Toronto (CA)

Correspondence Address: SANDRO MICIELI, Suite # 7, 100 ST. REGIS CR, South, TORONTO, ON, M3J 1Y8, CA

(21) Appl. No.: 12/074,192

(22) Filed: Mar. 3, 2008

(30) Foreign Application Priority Data
Jan. 30, 2006 (CA) 2534793

(51) Int. Cl. G06Q 50/00

(52) U.S. Cl. 705/2

(57) ABSTRACT

A medical touch terminal literacy system and method used to display particular parts of the human anatomy, conditions, ailments and diseases. The delivering service is done by a touch screen terminal operated by a physician and/or health professional to a patient with a medical condition. The touch screen terminal will also be displaying information promoting health awareness. The systems main purpose is to improve health communication/awareness and includes the ability to make the patient obtain and understand basic and/or complicated health information. The system focuses on health information with simple medical images and terminology, which presents clear and concise communication between a health professional and their patient (s). This system has the capability of prescription writing and printing through the terminal on the touch screen keyboard display and includes a medical library.

The invention system and method is to engender the health literacy system between a medical provider and a patient. The system uses a terminal with a touch activated interface to display and facilitate specific regions of the human body, along with the conditions, ailments and diagnosis' to a patient. A system for providing health care education through a touch activated terminal system that uses a visual display interface for employing common medical conditions, ailments, diseases, body regions and diagnosis to a patient. The location of the terminal will be situated in the physicians/medical provider's examination room (s) and/or office (s).

The physician/medical provider selects a region of the body by touching the terminal, FIG. 1. The selected area highlights to confirm the selection, FIG. 2.1, an additional sub-menu, FIG. 2.2 and FIG. 2.3, displays along the right margin of the system interface. The sub-menus allow the viewing of additional information relating to the area selected. The information will then be displayed on a second interface, which is herein considered the diagnostic interface, FIG. 3. This diagnostic interface is comprised of an anatomy gallery, which is located on the left margin, FIG. 3.1. The anatomy gallery has scrolling capabilities and contains images and descriptions of the regions and/or common conditions. When the gallery image is selected, FIG. 3.1, a super-imposed image is viewed in the diagnostic frame, FIG. 3.5. A quick-jump button, FIG. 3.3, located at the bottom right hand corner, allows the physician/medical provider to quickly switch between the region interface and the condition interface. A tool menu, located right margin, provides a drawing, painting and zooming function of the diagnostic frame, FIG. 3.4. Once the physician/medical provider completes the examination and diagnostic review, he/she is now capable of prescribing any medication necessary, FIG. 4.

The prescription writer system is comprised with a touch activated keyboard, FIG. 4.1, bottom left hand side of the screen. A medical library, FIG. 4.2, a prescription pad, FIG. 4.3, and a printing and delivering system, FIG. 4.4. The medical library has alphabetical recognition once the physician/medical provider enters the medication name. The medication name, mitte, sig, quantity, and repeats can be added to the med pad, FIG. 4.3. When a prescription is complete, it then forwards the prescription to the printing device attached to the terminal or transferred directly to the desired pharmacist.

### DRAWINGS

FIG. 1 shows the main interface displaying the human anatomy.

FIG. 2 shows the interface displaying the human anatomy with selectable regions.

FIG. 2.1 shows the selected region.

FIG. 2.2 shows the sub-menu button to the selected region.

FIG. 2.3 show the sub-menu button to the condition/ailments related to the selected region.

FIG. 3 shows the view of the diagnostic interface.

FIG. 3.1 shows the diagnostic interface selectable menu.

FIG. 3.2 shows the media from the selectable menu.

FIG. 3.3 shows the quick jump button, to and from human regions/conditions and ailments.

FIG. 3.4 shows the tool menu with selectable colours.

FIG. 3.5 shows diagnostic frame.

FIG. 4 shows the prescription writing tool interface.

FIG. 4.1 shows the touch screen keyboard with the medication display.

FIG. 4.2 displays the medical library.

FIG. 4.3 displays the medications ready to be prescribed and printed.

FIG. 4.4 displays the printing and delivery system.

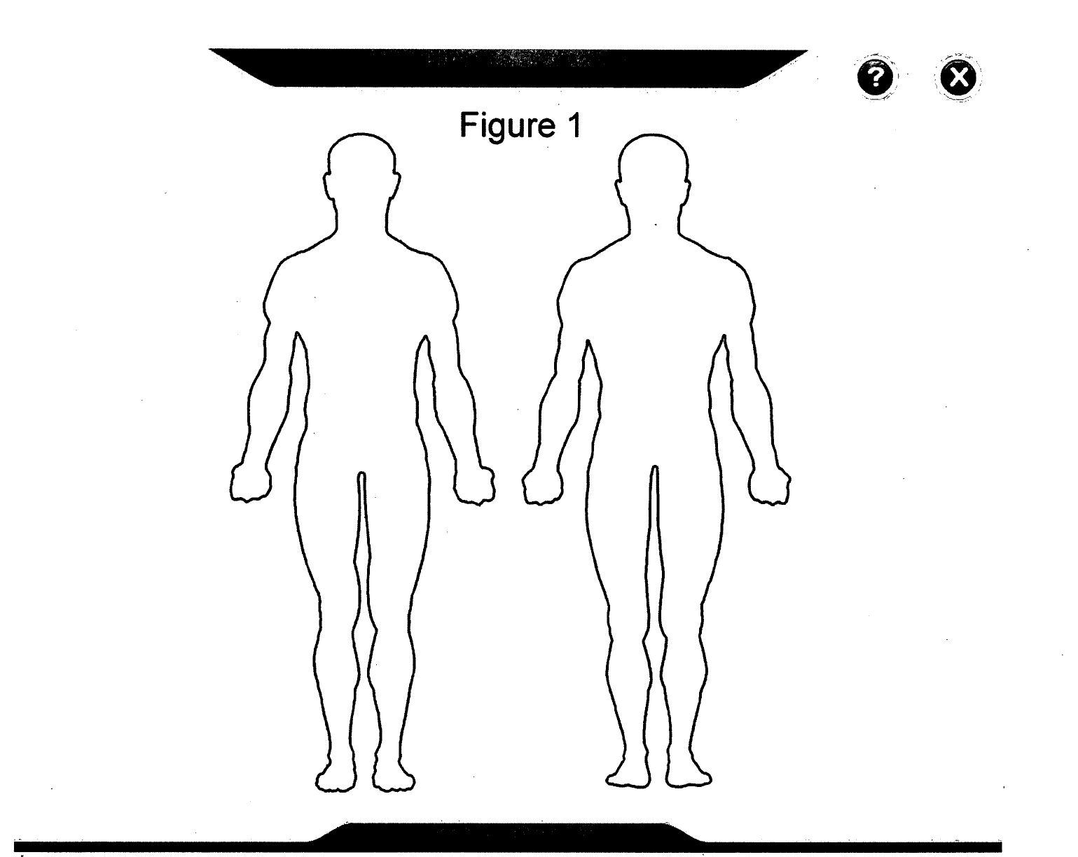

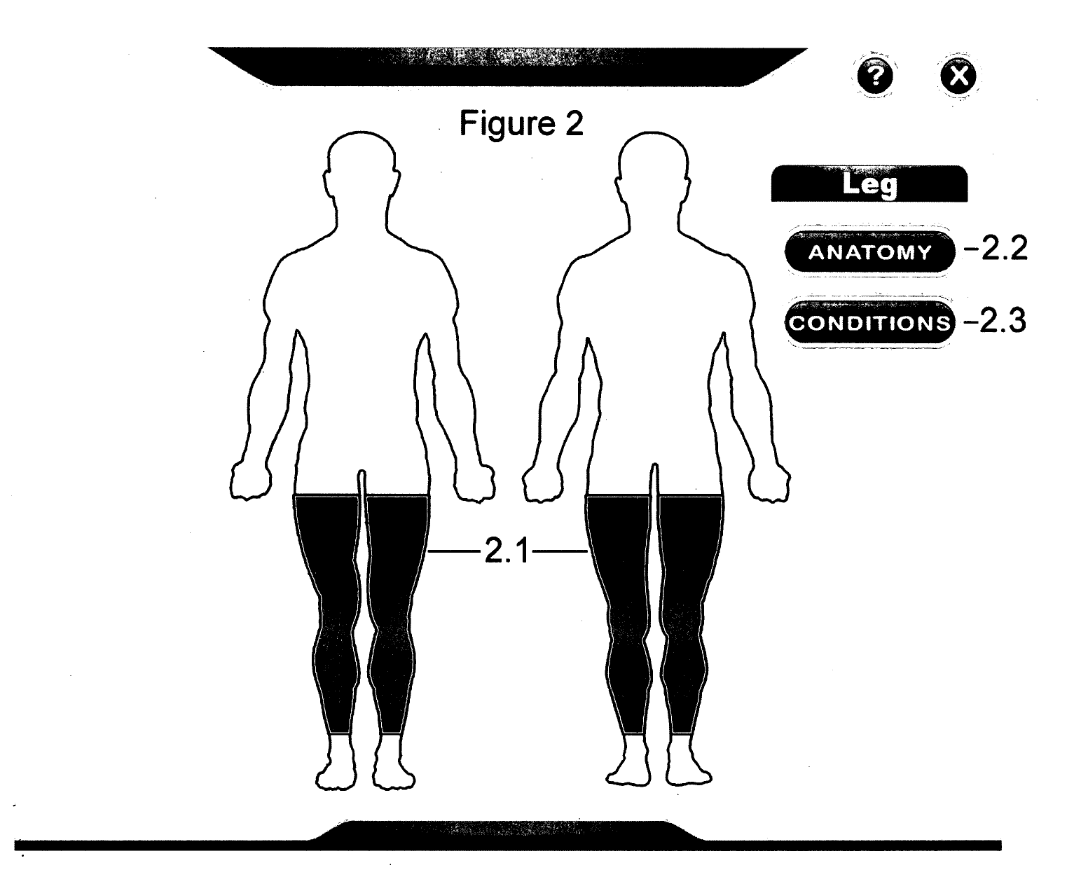

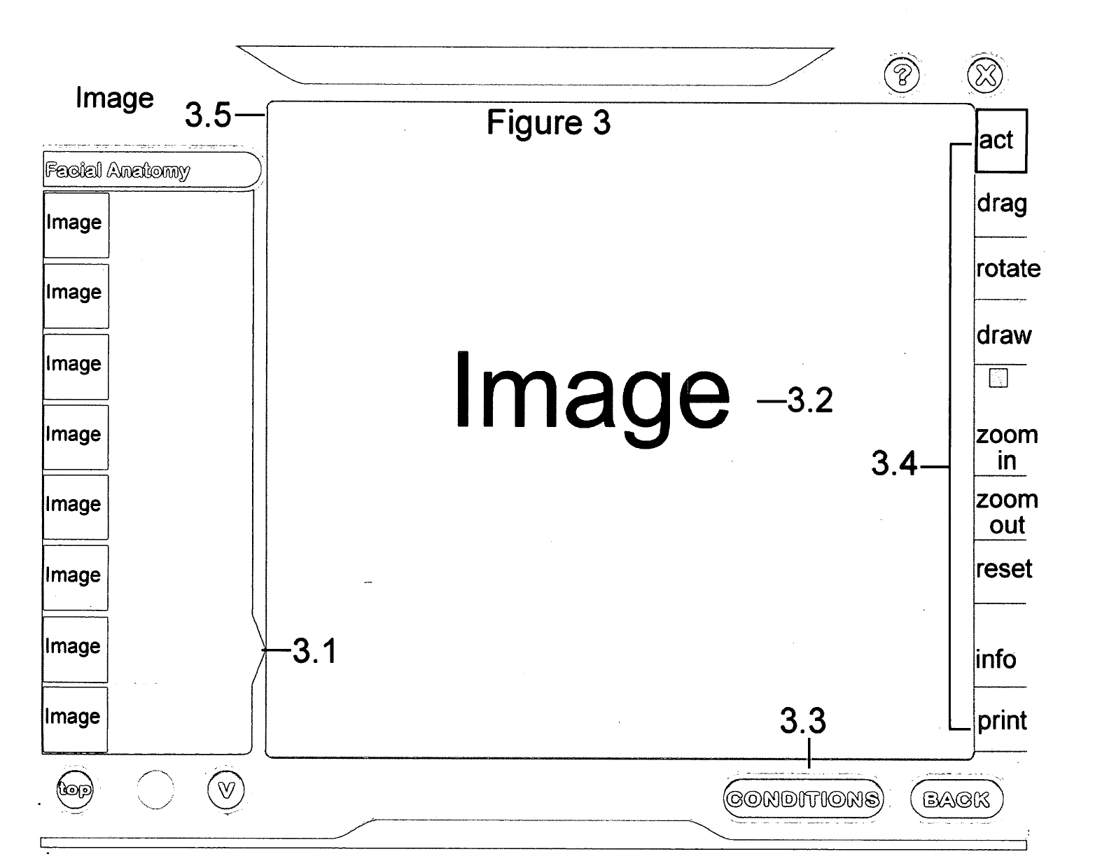

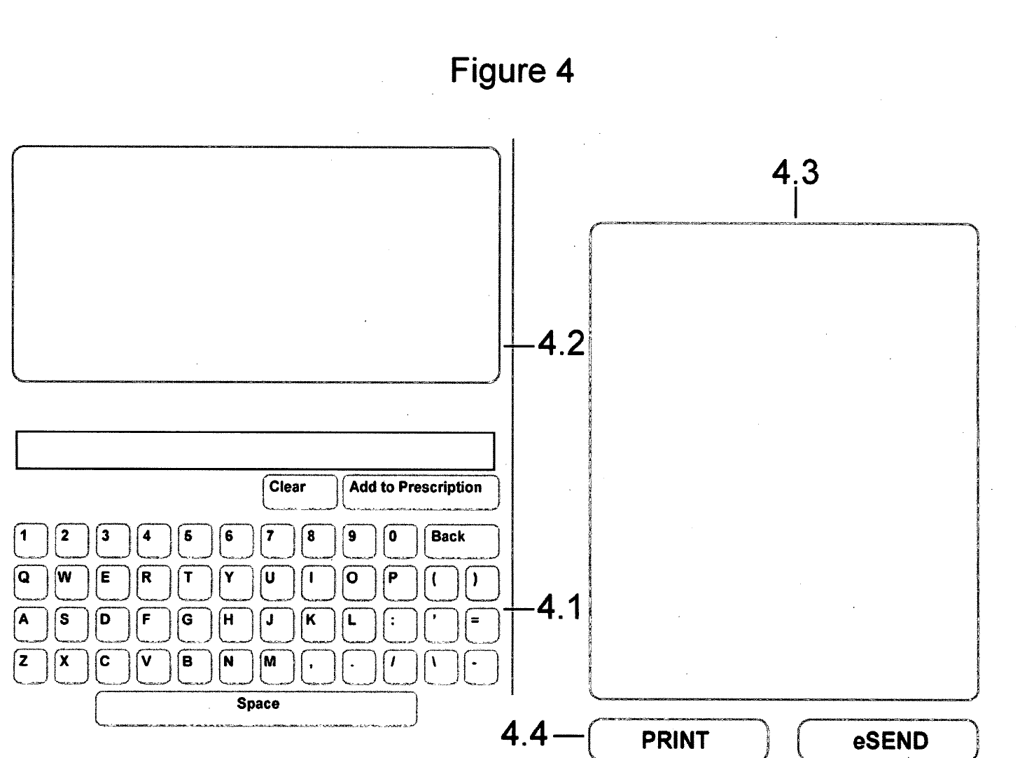

The embodiments of the invention in which an exclusive property or privilege is claimed are defined as followed:

1. A medical literacy method and system used to display human anatomy, body parts, regions, conditions, ailments, diseases and diagnosis of the human body. A system for displaying digital graphics and medias.
These terminals are placed in health care provider's examination rooms and/or offices. The terminals are touch screen activated and can use any pointing device (i.e. stylus pen, finger, or beam,).
The touch screen is generally known. Such touch screen is used in front of a computer driven display that is capable of displaying various images or a non-variable display that is capable of providing fixed images. Such touch screen may sense or recognize the existence and location on its exterior surface so that a user may input commands to an accessory-general purpose computer. The touch screen may be resistive or capacitive, analog or matrix.
The terminal would be fixed on an LCD arm, radical or articulating arm, pole system, wall mounted, free standing, and/or a portable wireless device.
The patient would view the touch terminal while waiting for the practitioner. The physician or care giver would access the interface with the pointing device of their choice. A full front and rear image of the human body will be displayed on the screen, the physician would then select the area to display (i.e. touches the abdominal region of the interface, a sub-menu selection will appear, conditions, regions, diseases, or parts). A second interface appears allowing the doctor to obtain detailed images or information of the selected region/condition.
Should the physician/medical provider need to go into detail with respect to a certain medical ailment or surgical procedure the physician/medical provider can make any drawings on the touch screen with the draw tool giving the patient a more detailed and concise explanation.
